(19) United States
(12) Patent Application Publication
(10) Pub. No.: US 2017/0354891 A1
(43) Pub. Date: Dec. 14, 2017

(54) USER INTERFACE FOR LIVE STREAMING GAME PLAY INCLUDING USER CONTROLS

(71) Applicant: Sony Interactive Entertainment LLC, San Mateo, CA (US)

(72) Inventors: Kohichi Aoki, San Francisco, CA (US); Katsuya Hyoda, San Francisco, CA (US); Sneha Singh, San Francisco, CA (US)

(21) Appl. No.: 15/469,108

(22) Filed: Mar. 24, 2017

Related U.S. Application Data
(60) Provisional application No. 62/349,534, filed on Jun. 13, 2016.

(51) Int. Cl. A63F 13/67; A63F 13/332; A63F 13/213; A63F 13/24; G06F 9/44

(52) U.S. Cl. CPC A63F 13/67; A63F 13/24; G06F 9/4443; A63F 13/213; A63F 13/332; A63F 2300/406

(57) ABSTRACT

A user interface for live streaming game play including user controls enables users to play a video game by providing input with a device and see the provided input on the screen which enables users to analyze the input provided including reviewing strategy analytics. Users are also able to retrieve/share the input/analytics from/to other users.

### CROSS-REFERENCE TO RELATED APPLICATION(S)

This application claims priority under 35 U.S.C. §119(e) of the U.S. Provisional Patent Application Ser. No. 62/349,534, filed Jun. 13, 2016 and titled, “USER INTERFACE FOR LIVE STREAMING GAME PLAY INCLUDING USER CONTROLS,” which is hereby incorporated by reference in its entirety for all purposes.

### FIELD OF THE INVENTION

The present invention relates to video games. More specifically, the present invention relates to a user interface for video games.

### BACKGROUND OF THE INVENTION

Playing video games and sharing videos of video games are currently very popular. Sharing videos of other users playing is only partially helpful because watching a video does not provide all of the details needed to become better at playing a video game.

### SUMMARY OF THE INVENTION

A user interface for live streaming game play including user controls enables users to play a video game by providing input with a device and see the provided input on the screen which enables users to analyze the input provided including reviewing strategy analytics. Users are also able to retrieve/share the input/analytics from/to other users.

In one aspect, a method programmed in a non-transitory memory of a device comprises processing a video game, recording controller input from a controller device for the video game and displaying the controller input on a user interface while processing the video game. Processing the video game is by a video game console. Processing the video game is by a network device providing the video game via live streaming. The controller device comprises a controller, a joystick, a musical instrument, or a camera. Displaying the controller input on the user interface includes overlaying the user interface on video game content. Displaying the controller input on the user interface includes scrolling the controller input while new controller input is received. The method further comprises generating strategy analytics based on the controller input and displaying the strategy analytics. The method further comprises sharing the controller input with another device.

In another aspect, a server device comprises a non-transitory memory for storing an application, the application for: processing a video game, recording controller input from a controller device for the video game and providing the controller input to be displayed on a user interface and a processor coupled to the memory, the processor component configured for processing the application. The controller device comprises a controller, a joystick, a musical instrument, or a camera. Providing the controller input to be displayed on the user interface includes overlaying the user interface on video game content. The server device further comprises generating strategy analytics based on the controller input. The server device further comprises sharing the controller input with another device.

In another aspect, a system comprises a controller device configured for receiving input from a user and a game console configured for playing a video game, capturing controller input from the game controller device and sending the controller input to be displayed with the video game. The game console receives the video game from a network device via live streaming. The controller device comprises a controller, a joystick, a musical instrument, or a camera. The controller input is displayed with a user interface by overlaying the user interface on video game content. The controller input is displayed on the user interface by scrolling the controller input while new controller input is received. The game console is further configured for generating strategy analytics based on the controller input. The game console is further configured for sharing the controller input with another device.

### BRIEF DESCRIPTION OF THE DRAWINGS

FIGS. 1-5 illustrate screenshots of video games with a user interface including captured user controls according to some embodiments.

FIG. 6 illustrates a screenshot of a channel listing with a user interface including captured user controls according to some embodiments.

FIG. 7 illustrates a screenshot of strategy analytics according to some embodiments.

FIG. 8 illustrates a flowchart of a method of implementing the user interface for live streaming game play including user controls according to some embodiments.

FIG. 9 illustrates a block diagram of an exemplary computing device configured to implement the user interface with control input information method according to some embodiments.

FIG. 10 illustrates a diagram of a network of devices according to some embodiments.

### DETAILED DESCRIPTION OF THE PREFERRED EMBODIMENT

A user interface for live streaming game play with user controls provides a custom user interface to accompany a live streaming video game (or other video game) which displays key input and analysis on top of the game. In some embodiments, the key input is overlaid on/into the game from the gaming console or with a cloud implementation. Unlike merely displaying a video of a video game with input, the captured input is displayed on a playable video game while the user is playing the video game. By capturing controller input to a system (e.g., PS4 game console), the system is then able to present the controller input on the display (e.g., using WebView) as part of the user interface. The key/controller input is able to be displayed in real-time via a cloud implementation (or another implementation) with or without deep learning/server-side logic for the client/user device. In some embodiments, the key/controller input is context-oriented information such as based on current game settings/actions/situations. The user interface is able to provide suggestions based on machine learning. The user interface is able to save the controller input and play back the controller input at desired/automatically determined times. A user is able to save his controller input and send/sell the input to other users. For example, an professional gamer plays a game and uses the system to record his controller input. Other users (e.g., novices) are able to then purchase his controller input to learn and improve their own skills. The controller input is able to be saved as any type of data file which is able to be utilized/integrated by a game/system to display the saved controller input. In some embodiments, the controller input includes multi-player support such that when multiple users are playing a game, each of their controller inputs are captured and saved.

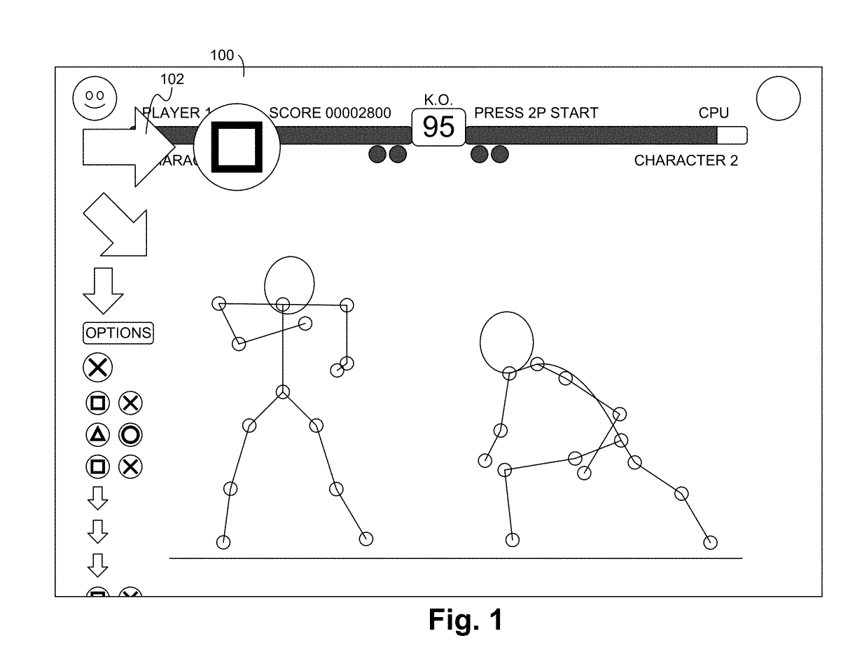

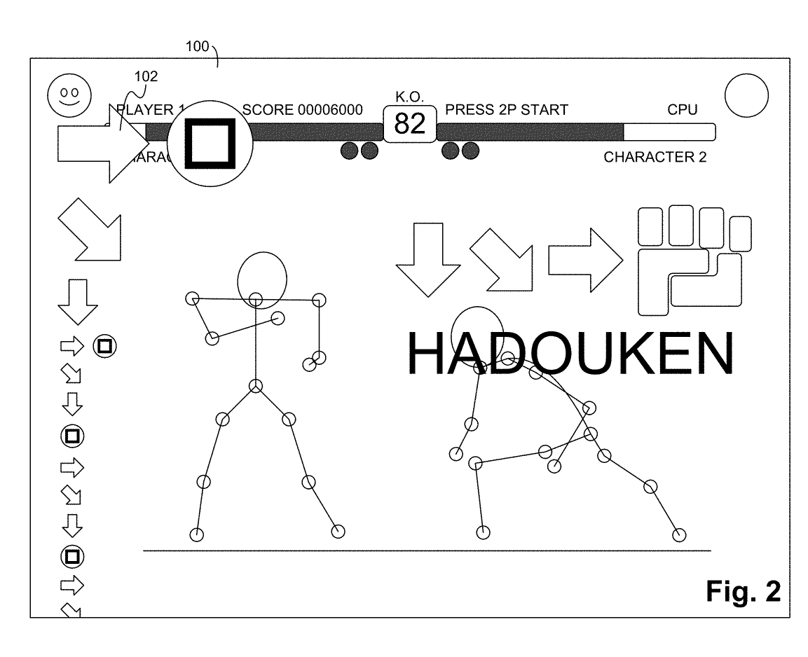

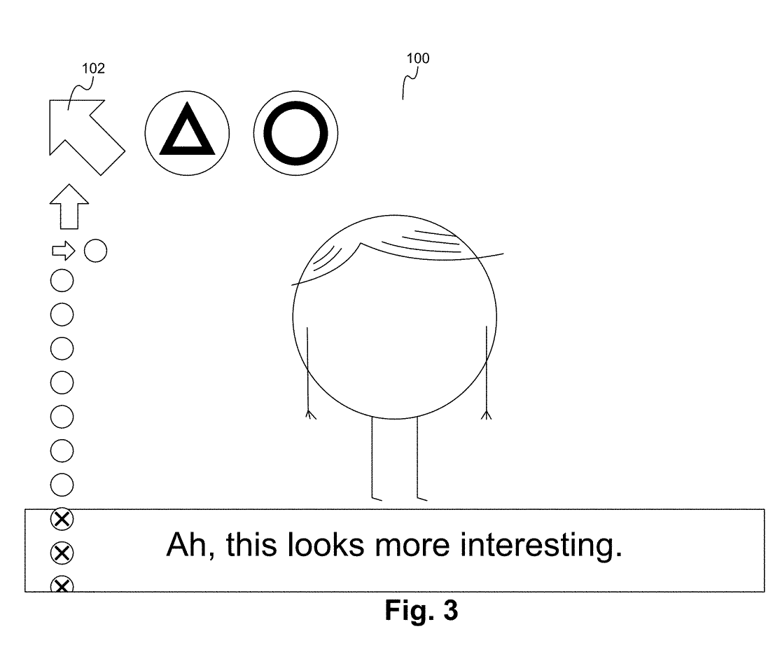

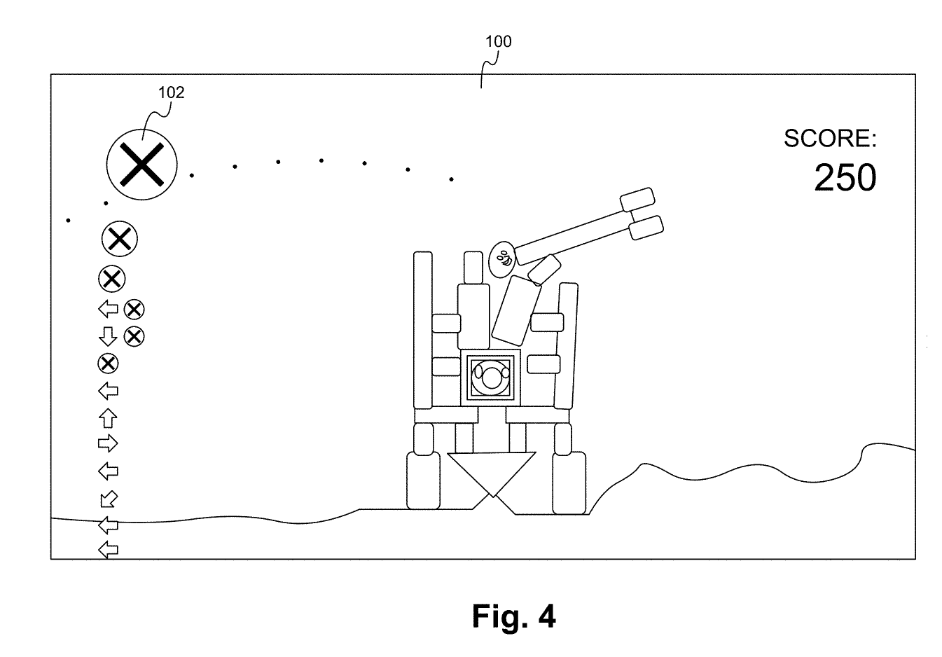

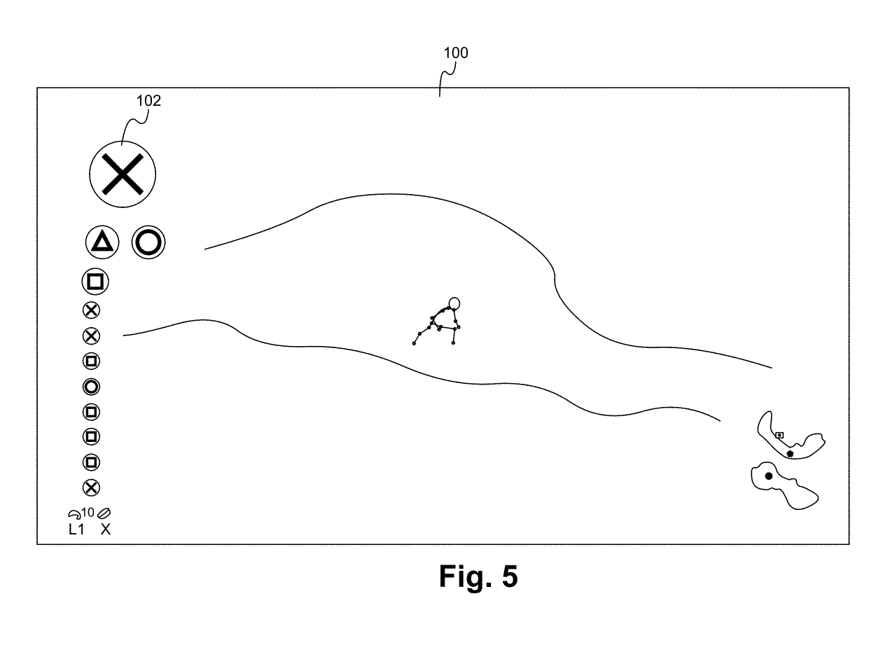

FIGS. 1-5 illustrate screenshots of video games with a user interface including captured user controls according to some embodiments. While a user plays the game, his controller input 102 is captured and displayed on the screen with the game content 100. The controller input is able to be captured in any manner such as the game software including a routine which receives the input (e.g., signals based on a user pressing/moving buttons/controller) from the controller and storing the input, or supplemental software such as network software monitoring and captureing the controller input. The input does not have to be from a handheld controller, the input is able to be detected and captured from a wand device, detecting physical user movements where a handheld device is or is not utilized, voice input, eye movement, head/body movement, and/or any other user input is able to be detected and captured.

The controller input is able to be displayed in any manner. In some embodiments, the controller input is displayed on the same screen as the video game being played, and in some embodiments, the controller input is displayed on a second screen different from the video game being played. The controller input is able to be displayed on any portion of the screen such as left side, right side, top, bottom, any of the corners, over a character (e.g., same character that is being controlled by the controller input). The controller input is able to move/scroll in any direction as additional controller input is captured and displayed. For example, the controller input scrolls down from the top to the bottom with new controller input appearing at the top and older controller input disappearing at the bottom. In some embodiments, the controller input is displayed by being embedded in the video game output, and in some embodiments, the controller input is displayed as a separate user interface which is overlaid on the video game.

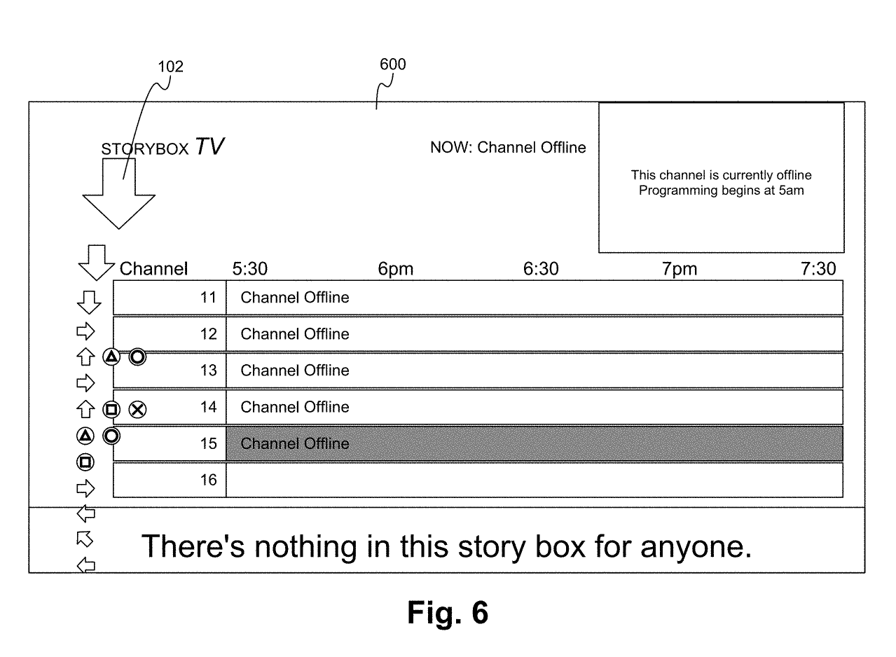

FIG. 6 illustrates a screenshot of a channel listing with a user interface including captured user controls according to some embodiments. In addition to or instead of gaming, the user interface with user control input 102 is able to be utilized with television programming 600, video playback (e.g., DVD, Blu-ray®), and/or any other displayed content. For example, the user's use of the controls are displayed on the side to show the input to reach the current point. The user is able to use the displayed control input to reverse his steps to go to a previous point. For example, if the user sees the control input displayed on the side show up, down, left, left, then the user is able to press down, up, right, right to return to the original position.

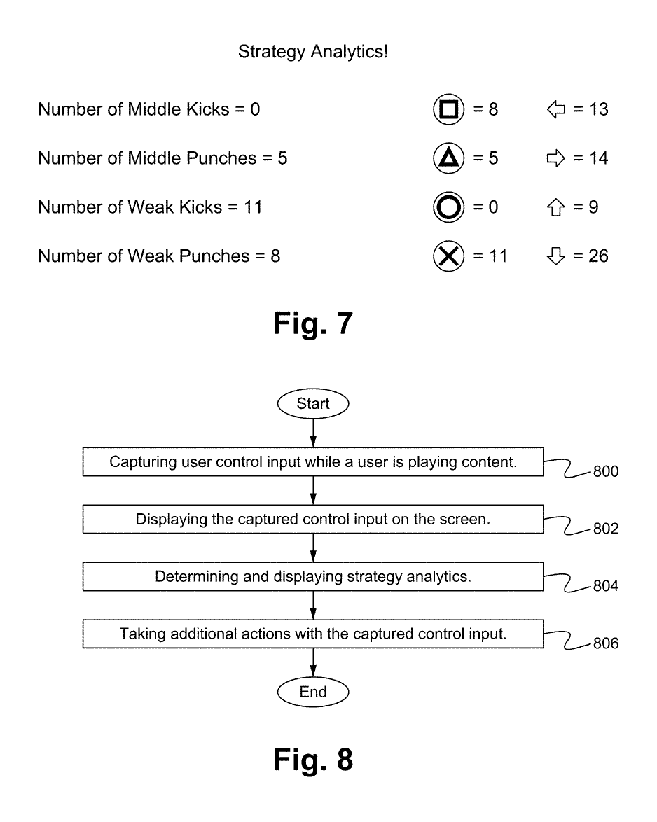

FIG. 7 illustrates a screenshot of strategy analytics according to some embodiments. The strategy analytics are able to be displayed on a separate screen (e.g., without the game in the background). The strategy analytics are overlaid on or embedded with the game. For example, the strategy analytics are kept track live in a corner box display to show the user statistics regarding the controller input. The strategy analytics are based on capturing controller input. As described herein, the controller input is able to be captured in any manner. The game and/or system (e.g., console) is able to know or determine what each input equates to. For example, in Game X, the square button is a weak punch, the circle button is a middle kick and so on. Then, based on the number of presses of each button, statistical information is able to be generated as shown, such as 8 weak punches, 5 middle punches and so on. Additionally, the movement controls (e.g., left, right, up and down) are also able to be tracked and captured. In addition to simple button capture, button combinations are able to be captured, highlighted and analyzed. For example, button combinations (e.g., to perform a special move) are able to be grouped together (e.g., displayed horizontally when separate control inputs are displayed vertically, color-coded such that the input for a combination has the same color or any other indication of the combination. Additionally, when displaying strategy analytics, the combinations are able to be listed along with any statistical information. For example, in addition to the 4 control inputs shown, a “number of super kicks” listing is displayed with the corresponding number, and the button combination of square+circle is shown with the corresponding number. The strategy analytics is able to be used for any purpose such as learning or comparative purposes.

FIG. 8 illustrates a flowchart of a method of implementing the user interface for live streaming game play including user controls according to some embodiments. In the step 800, user control input is captured while a user is playing content such as a live streaming video game, a non-streamed video game, television content, or disc content (e.g., DVD). The control input is able to be acquired from a device such as a video game controller, joystick, camera, musical instrument, voice control, body motion control, and/or any other implementation. In the step 802, the captured control input is displayed on the screen. The captured control input is displayed in real-time. The captured control input is able to be included with the gaming content or overlaid as a separate user interface on the gaming content. In the step 804, strategy analytics are determined and displayed. The strategy analytics are determined using the captured control inputs such as determining which control input corresponds to which effect (e.g., kick, punch, jump, movement). In the step 806, additional actions are taken with the captured control input. For example, a user is able to post or share the captured control input and/or the strategy analytics with or without accompanying video game data. Furthering the example, a user is able to share the captured control input with a group of contacts through the Play Station Network or another network (e.g., social network). In some embodiments, fewer or additional steps are implemented. In some embodiments, the order of the steps is modified.

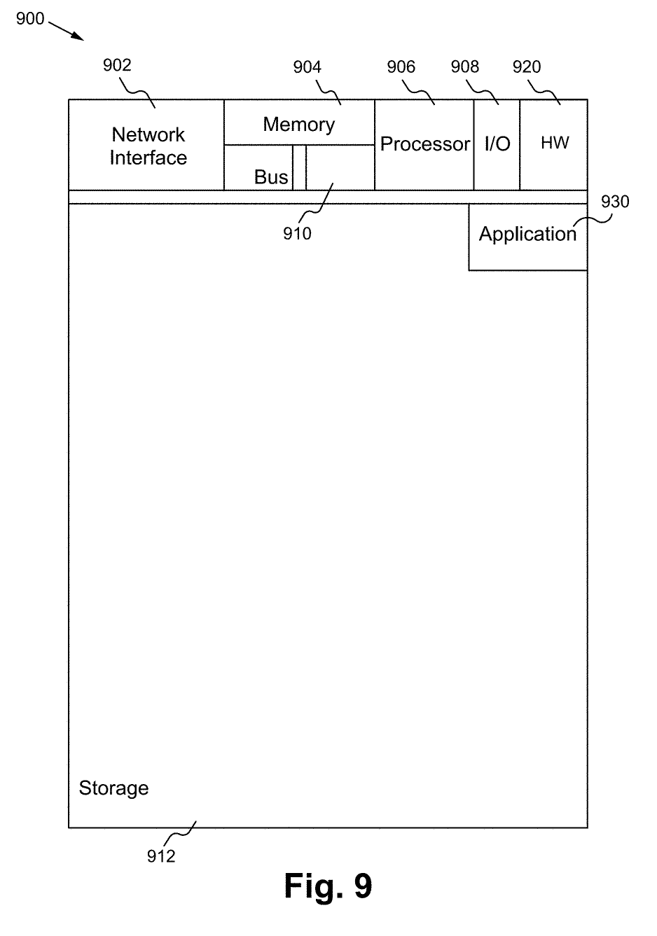

FIG. 9 illustrates a block diagram of an exemplary computing device configured to implement the user interface with control input information method according to some embodiments. The computing device 900 is able to be used to acquire, store, compute, process, communicate and/or display information such as images, videos, and video game content. In general, a hardware structure suitable for implementing the computing device 900 includes a network interface 902, a memory 904, a processor 906, I/O device(s) 908, a bus 910 and a storage device 912. The choice of processor is not critical as long as a suitable processor with sufficient speed is chosen. The memory 904 is able to be any conventional computer memory known in the art. The storage device 912 is able to include a hard drive, CDROM, CDRW, DVD, DVDRW, High Definition disc/drive, ultra-HD drive, flash memory card or any other storage device. The computing device 900 is able to include one or more network interfaces 902. An example of a network interface includes a network card connected to an Ethernet or other type of LAN. The I/O device(s) 908 are able to include one or more of the following: keyboard, mouse, monitor, screen, printer, modem, touchscreen, button interface and other devices. User interface application(s) 930 used to perform the user interface with control input information method are likely to be stored in the storage device 912 and memory 904 and processed as applications are typically processed. More or fewer components shown in FIG. 9 are able to be included in the computing device 900. In some embodiments, user interface hardware 920 is included. Although the computing device 900 in FIG. 9 includes applications 930 and hardware 920 for the user interface with control input information method, the user interface with control input information method is able to be implemented on a computing device in hardware, firmware, software or any combination thereof. For example, in some embodiments, the user interface applications 930 are programmed in a memory and executed using a processor. In another example, in some embodiments, the user interface hardware 920 is programmed hardware logic including gates specifically designed to implement the user interface with control input information method.

In some embodiments, the user interface application(s) 930 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, smart jewelry (e.g., smart watch) or any other suitable computing device.

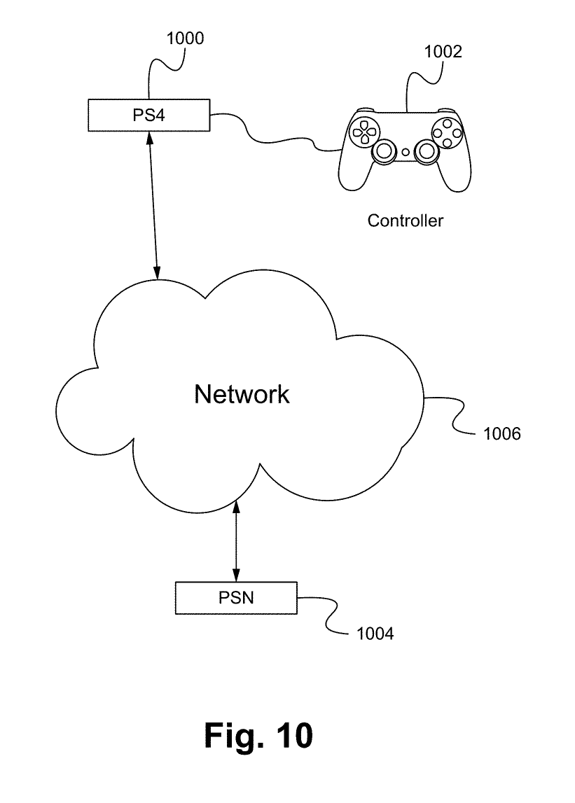

FIG. 10 illustrates a diagram of a network of devices according to some embodiments. The network of devices includes a gaming console (e.g., PS4/Xbox) 1000, an input device (e.g., controller, musical instrument) 1002, a network device (e.g., PSN server) 1004 and a network 1006. The network 1006 is able to be any type of network such as a cellular network, wi-fi, the Internet or a combination thereof. The network of devices is able to include fewer or additional devices such as many gaming consoles or network devices. As described herein, a user plays a video game using the gaming console 1000 by providing input with an input device 1002. The gaming console 1000, the game (e.g., software) and/or the network device 1004 automatically capture the control input received from the input device 1002 and/or generate strategy analytics based on the captured control input. The game console 1000 (in conjunction with a monitor/TV) displays the captured control input and/or strategy analytics as described herein.

In some embodiments, the game is streamed using the network 1006 and the network device 1004. For example, the network device 1004 processes the game components and sends the content to the gaming console 1000 for display locally for the user. The network device 1004 receives input from the input device 1002 and processes the game based on the received input. Additionally, the gaming console 1000 and/or the network device 1004 capture the control input to display with the game content and/or as a separate user interface.

To utilize the user interface with control input information, users play a video game by providing input with a device, the video game (or system) records the input and displays the input on the screen.

In operation, the user interface with control input information enables users to: see previous controller input, review strategy analytics, and retrieve/share the input/analytics from/to other users which increases enjoyment of the game and improves the functionality of the game or other content.

Although the video game sharing method and system has been described in relation to video game consoles, any digital/electronic video game (e.g., a smart phone app) is able to utilize the video game sharing method and system.

### Some Embodiments of a User Interface for Live Streaming Game Play Including User Controls

1. A method programmed in a non-transitory memory of a device comprising:

processing a video game;

recording controller input from a controller device for the video game; and

displaying the controller input on a user interface while processing the video game.
2. The method of clause 1 wherein processing the video game is by a video game console.
3. The method of clause 1 wherein processing the video game is by a network device providing the video game via live streaming.
4. The method of clause 1 wherein the controller device comprises a controller, a joystick, a musical instrument, or a camera.
5. The method of clause 1 wherein displaying the controller input on the user interface includes overlaying the user interface on video game content.
6. The method of clause 1 wherein displaying the controller input on the user interface includes scrolling the controller input while new controller input is received.
7. The method of clause 1 further comprising generating strategy analytics based on the controller input and displaying the strategy analytics.
8. The method of clause 1 further comprising sharing the controller input with another device.
9. A server device comprising:

a non-transitory memory for storing an application, the application for:
processing a video game;
recording controller input from a controller device for the video game; and
providing the controller input to be displayed on a user interface; and

a processor coupled to the memory, the processor component configured for processing the application.
10. The server device of clause 9 wherein the controller device comprises a controller, a joystick, a musical instrument, or a camera.
11. The server device of clause 9 wherein providing the controller input to be displayed on the user interface includes overlaying the user interface on video game content.
12. The server device of clause 9 further comprising generating strategy analytics based on the controller input.
13. The server device of clause 9 further comprising sharing the controller input with another device.
14. A system comprising:

a controller device configured for receiving input from a user; and

a game console configured for playing a video game, capturing controller input from the game controller device and sending the controller input to be displayed with the video game.
15. The system of clause 14 wherein the game console receives the video game from a network device via live streaming.
16. The system of clause 14 wherein the controller device comprises a controller, a joystick, a musical instrument, or a camera.
17. The system of clause 14 wherein the controller input is displayed with a user interface by overlaying the user interface on video game content.
18. The system of clause 14 wherein the controller input is displayed on the user interface by scrolling the controller input while new controller input is received.
19. The system of clause 14 wherein the game console is further configured for generating strategy analytics based on the controller input.
20. The system of clause 14 wherein the game console is further configured for sharing the controller input with another device.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
processing a video game;
recording controller input from a controller device for the video game; and
displaying the controller input on a user interface while processing the video game.

2. The method of claim 1 wherein processing the video game is by a video game console.

3. The method of claim 1 wherein processing the video game is by a network device providing the video game via live streaming.

4. The method of claim 1 wherein the controller device comprises a controller, a joystick, a musical instrument, or a camera.

5. The method of claim 1 wherein displaying the controller input on the user interface includes overlaying the user interface on video game content.

6. The method of claim 1 wherein displaying the controller input on the user interface includes scrolling the controller input while new controller input is received.

7. The method of claim 1 further comprising generating strategy analytics based on the controller input and displaying the strategy analytics.

8. The method of claim 1 further comprising sharing the controller input with another device.

9. A server device comprising:
a non-transitory memory for storing an application, the application for:
processing a video game;
recording controller input from a controller device for the video game; and
providing the controller input to be displayed on a user interface; and
a processor coupled to the memory, the processor component configured for processing the application.

10. The server device of claim 9 wherein the controller device comprises a controller, a joystick, a musical instrument, or a camera.

11. The server device of claim 9 wherein providing the controller input to be displayed on the user interface includes overlaying the user interface on video game content.

12. The server device of claim 9 further comprising generating strategy analytics based on the controller input.

13. The server device of claim 9 further comprising sharing the controller input with another device.

14. A system comprising:
a controller device configured for receiving input from a user; and
a game console configured for playing a video game, capturing controller input from the game controller device and sending the controller input to be displayed with the video game.

15. The system of claim 14 wherein the game console receives the video game from a network device via live streaming.

16. The system of claim 14 wherein the controller device comprises a controller, a joystick, a musical instrument, or a camera.

17. The system of claim 14 wherein the controller input is displayed with a user interface by overlaying the user interface on video game content.

18. The system of claim 14 wherein the controller input is displayed on the user interface by scrolling the controller input while new controller input is received.

19. The system of claim 14 wherein the game console is further configured for generating strategy analytics based on the controller input.

20. The system of claim 14 wherein the game console is further configured for sharing the controller input with another device.
